(19) United States
(12) Patent Application Publication
(10) Pub. No.: US 2004/0006572 A1
(43) Pub. Date: Jan. 8, 2004

(54) Method and system for employing and managing storage

(75) Inventors: Shinichi Hoshino, Kawasaki (JP); Nobuyuki Yamashita, Yokohama (JP); Hiroshi Nojima, Fujisawa (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, ltd., Tokyo (JP)

(21) Appl. No.: 10/222,424

(22) Filed: Aug. 15, 2002

(30) Foreign Application Priority Data
Apr. 10, 2002 (JP) 2002-107280

(51) Int. Cl. G06F 17/00

(52) U.S. Cl. 707/104.1

(57) ABSTRACT

A storage employing and managing system, under the environment in which a user performs the setting of storage apparatuses, acquires the condition for the storage apparatus setting in the form of a policy from a user, acquires configuration information of the storage apparatuses, determines a combination of the settings satisfying the policy acquired from the user in the configuration information of the storage apparatuses, generates parameters for tools for manipulating the storage apparatuses such that the combination is set in the storage apparatuses, and calls the tools using the parameters to perform the setting of the storage apparatuses.

### BACKGROUND OF THE INVENTION

1. Field of the Invention

The present invention relates to a technology for employing and managing a storage area network, and more particularly to a technology for generating efficiently parameters for apparatuses when carrying out the apparatus setting, on the basis of a policy input from a user with respect to apparatus setting.

2. Description of the Related Art

A quantity of data dealt in enterprises has abruptly increased due to spread of electronic business transaction, increase in utilization of multi-media data and the like. For this reason, a storage area network (SAN) has been remarkable so that it can handle effectively a large quantity of data. The storage area network is such that a plurality of servers and a plurality of storages are operatively connected to one another through a fiber channel switch. In response to this trend of the times, the standardization such technology for managing the storage area network has been advanced by various kinds of technical associations.

On the other hand, currently, the flexibility of the apparatus configuration has increased due to introduction of the storage area network when an enterprise stores data, while a storage apparatus configuration becomes complicated, the setting for apparatuses handled by a system administrator becomes complicated, and the capacity and kinds of data handled by the system administrator have increased due to the centralized management of the storages.

The operation of the storage area network is carried out by manipulating tools for managing storage apparatuses such as servers, storages and switches, respectively. Consequently, the system administrator needs to carry out the operation for the storage apparatuses while keeping consistency between the storage apparatuses by manipulating individually all of those tools.

U.S. Pat. No. 6,295,575 describes a configuring method of a vector exhibiting which server may access to a storage in the management of the storage apparatuses.

In a conventional method, a system administrator carries out the operation of the storage area network by manipulating the tools for managing the storage apparatuses, respectively. For this reason, it is necessary that all of parameters used to set storage apparatuses are manually generated, and the consistency between the storage apparatuses is kept by carrying out the management so as not to appear differences in the parameters between the tools by the system administrator.

For example, even in the case where simple setting is carried out such that a storage is assigned to a server, the system/administrator needs to carry out the complicated manipulation as described below.

(1) Apparatus configuration information, such as which storage has how many empty areas or which port to be input or output data is in use, is checked using the tools specifically corresponding to the apparatuses.

(2) From the investigation result of the above-mentioned item (1), which storage and port are employed is determined so as not to influence any of the existing systems.

(3) Parameters reflected the contents determined in the above-mentioned item (2) are generated for the tools for manipulating the server, storage and switch, respectively, to thereby operate the tools.

It is a considerable problem to set automatically the parameters between the tools, in order to reduce the operation and management cost by the system administrator.

U.S. Pat. No. 6,295,575 describes the configuring method of a vector exhibiting which a server may access to a storage in the management of the storage apparatuses, but does not describe a method of automatically setting parameters in the operation of storage apparatuses.

### SUMMARY OF THE INVENTION

In order to solve the above-mentioned problems, it is therefore an object of the present invention to provide a storage employing and managing method and system capable of automatically setting parameters to reduce the operation and management cost by a system administrator.

In order to attain the above-mentioned object in the present invention, the following procedure is executed.

(1) The conditions used to set storage apparatuses are acquired as a policy from a user.

(2) Configuration information of the storage apparatuses is acquired.

(3) A combination of settings of the storage apparatuses to be satisfied the policy acquired from the user is determined on the basis of the configuration information of the storage apparatuses.

(4) In order to set the above-mentioned combination of settings in the storage apparatuses, parameters for tools for manipulating the storage apparatuses are generated.

(5) The tools are operated with use of the parameters to set the storage apparatuses.

From the above, it is possible to automate the parameter setting to reduce the operation and management cost by the system administrator.

Other objects, features and advantages of the invention will become apparent from the following description of the embodiments of the invention taken in conjunction with the accompanying drawings.

### BRIEF DESCRIPTION OF THE DRAWINGS

FIG. 1 is a conceptual view of the present invention;

FIG. 2 is a functional block and a hardware configuration of a storage employing and managing system according to an embodiment of the present invention;

FIG. 3 is a flow chart useful in explaining the processing procedure for generating newly parameters used to set storage apparatuses;

FIG. 4 is a flow chart useful in explaining the processing procedure for generating parameters used to set the storage apparatuses by reutilization; and

FIG. 5 is a flow chart useful in explaining the processing procedure for calling a storage apparatus setting tools.

### DESCRIPTION OF THE EMBODIMENT

The description will hereinafter be given with respect to a storage employing and managing system, according to an embodiment of the present invention, which is capable of automatically setting parameter.

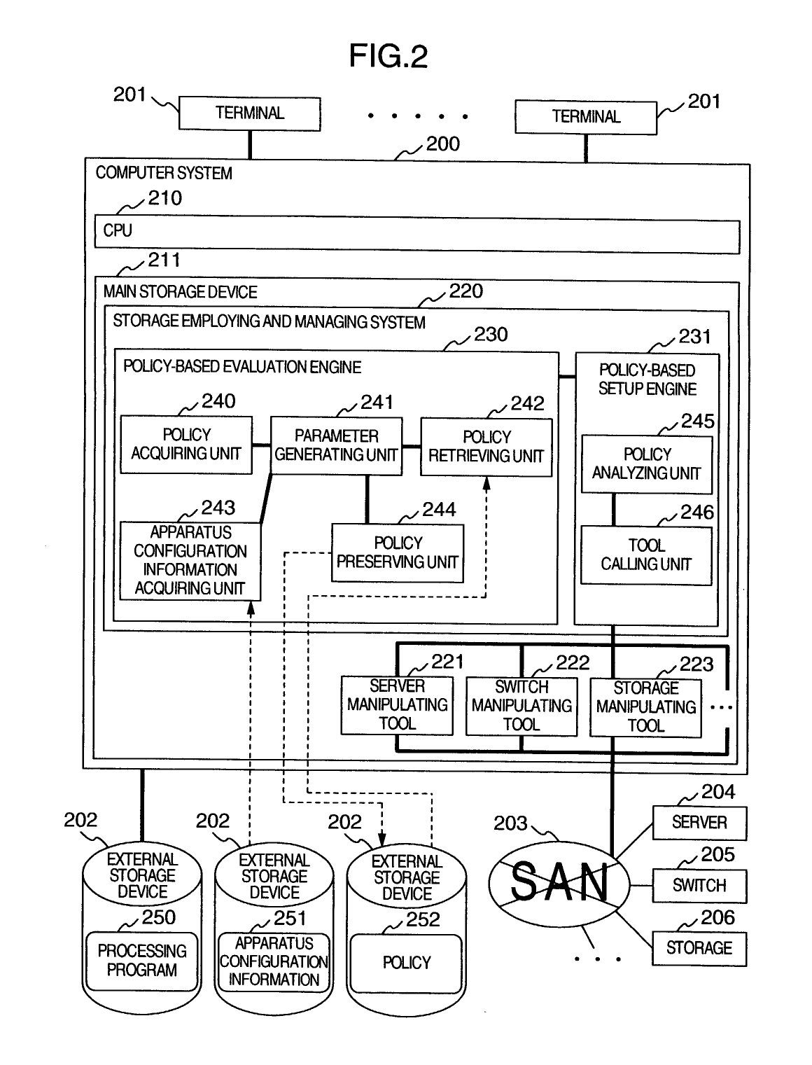

First of all, a functional block and a hardware configuration of a storage employing and managing system of the present invention will now be described with reference to FIG. 2.

A computer system 200 is constituted by a CPU 210, a main storage device 211, external storage devices 202 such as magnetic discs, a storage area network 203 becoming an object of the operation and management, a server 204, a switch 205 and a storage 206 constituting the storage area network 203. A storage employing and managing system 220, a server manipulating tool 221, a switch manipulating tool 222, a storage manipulating tool 223, and the like are stored in the main storage device 211. Apparatus configuration information 251 and a policy 252 set by a user in generating parameters, are stored in the external storage devices 202. In addition, a processing program 250 for realizing the storage employing and managing system 220, the server manipulating tool 221, the switch manipulating tool 222, and the storage manipulating tool 223, are also stored in another external storage device 202.

The storage employing and managing system 220 is constituted by a policy-based evaluation engine 230, and a policy-based setup engine 231. The policy-based evaluation engine 230 is constituted by a policy acquiring unit 240, a parameter generating unit 241, a policy retrieving unit 242, an apparatus configuration information acquiring unit 243, and a policy preserving unit 244. Also, the policy-based setup engine 231 is constituted by a policy analyzing unit 245 and a tool calling unit 246.

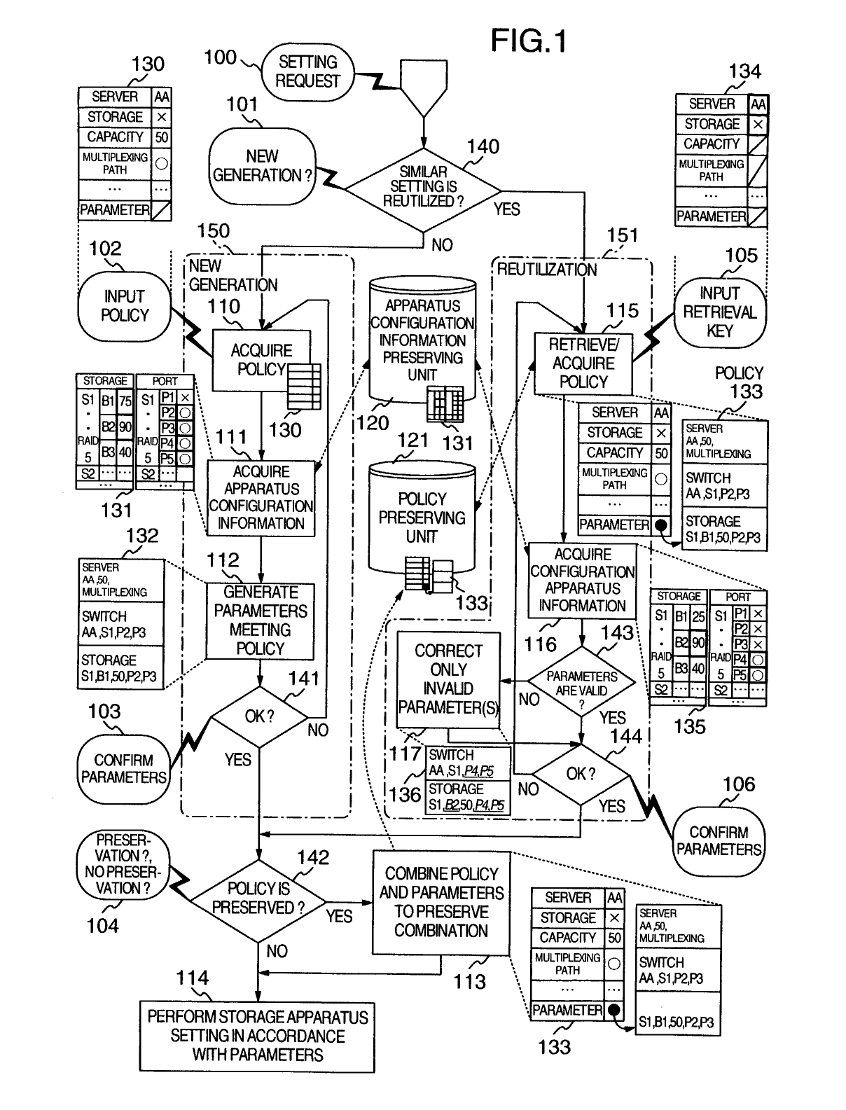

Next, the outline of the present invention will hereinbelow be described with reference to FIG. 1.

FIG. 1 is a flow chart useful in explaining a flow of generating of parameters in the storage employing and managing system of the present embodiment.

The storage employing and managing system 220 requests, in response to a setting request 100 from a user, a user to effect an input 101 for selection 140 with respect to whether or not a similar setting is reutilized. If a user selects the new generation of parameters, then parameters are generated in accordance with a flow 150 of the new generation. On the other hand, if the user selects reutilization of the parameters, then parameters are generated in accordance with a flow 151 of the reutilization. At first, the description will hereinbelow be given with respect to the flow 150 of the new generation when the user selects the new generation of parameters.

The storage employing and managing system 220, in the flow 150 of the new generation, first of all, executes a policy acquiring processing 110. The policy acquiring unit 240 requests a user to effect a policy input 102 to acquire a policy 130. The policy 130 is a condition for setting the storage apparatuses and is constituted by items consisting of a server name, storage name, storage capacity, information with respect to whether or not a multiplexing path is set, and the like.

Next, the apparatus configuration information acquiring unit 243 executes an apparatus configuration information acquiring processing 111. The apparatus configuration information acquiring unit 243 acquires apparatus configuration information 131 with respect to the server 204, the switch 205, the storage 206 and the like, from an apparatus configuration information preserving unit 120. The parameter generating unit 241 executes a parameter generating processing 112 to be satisfied the condition of policy from the policy 130 acquired from the user and the storage apparatus configuration information 131 to thereby generate parameters 132.

A policy-based evaluation engine 230 confirms the user whether or not the generated parameters 132 are intended for the user, i.e., whether or not those parameters 132 satisfies the condition specified in the policy (Step 141). Then, the user carries out parameter confirmation 103. If the user judges that those parameters 132 are not intended for the user, then the process returns back to the policy acquiring processing 110. On the other hand, if the user judges that those parameters 132 are intended for the user, then the policy-based evaluation engine 230 requests the user to effect the input 104 for the selection 142 with respect to whether or not the policy is preserved. If the user selects the preservation of the policy 130, then a processing 113 for combining the policy and the parameters with each other to preserve the combination thereof is executed. A combination 133 of the policy 130 acquired from the user and the parameters 132 generated by the parameter generating unit 241, is generated to be preserved in the policy preserving unit 121. After completion of the policy preserving processing 113 or if the user does not select the preservation of the policy, then a storage apparatus setting executing processing 114 is executed in accordance with the parameters.

Next, the description will hereinbelow be given with respect to a flow 151 of reutilization when the user selects reutilization of parameters.

In the flow 151 for reutilization, in order to reutilize the policy generated until now, the storage employing and managing system 220, first of all, executes a policy retrieving/acquiring processing 115. The policy retrieving unit 242 requests the user to effect a retrieval key input 105 to acquire a retrieval key 134. The user inputs, as the retrieval key 134, only the item which is wanted to be made a key in the same form as that of the policy 130. The policy retrieving unit 242 retrieves the policy satisfying the above-mentioned retrieval key 134 from the policy preserving unit 121 to acquire the policy 133.

Next, the apparatus configuration information acquiring unit 243 executes an apparatus configuration information acquiring processing 116. The apparatus configuration information acquiring unit 243 acquires apparatus configuration information 135 with respect to the server 204, the switch 205, the storage 206 and the like of the storage apparatus from the apparatus configuration information preserving unit 120. The parameter generating unit 241, by referring to the apparatus configuration information 135, judges whether or not the parameters combined with the acquired policy 133 are valid for the current apparatus configuration information 135 (Step 143). If it is judged in Step 143 that all of or some of the parameters are invalid, then the parameter generating unit 241 executes a processing 117 for correcting only the invalid parameter. After completion of the processing 117 for correcting only the invalid parameter or if it is judged in Step 143 that the parameters are valid, then the policy-based evaluation engine 230, similarly to Step 141, confirms the user whether or not the parameters are intended for the user (Step 144). Then, a user carries out the confirmation 106 of the parameters. If the user judges that the parameters are not intended for the user, then the process returns back to the policy retrieving/acquiring processing 115.

On the other hand, if the user judges that the parameters are intended for the user, then the policy-based evaluation engine 230 requests the user to effect the input 104 for the selection 142 with respect to whether or not the policy is preserved. If the user selects the preservation of the policy, then a processing 113 for combining the policy and the parameters with each other to preserve the combination thereof is executed. The combination of the retrieved policy 133 and the parameters 136 for which the correction processing is executed only when the current apparatus configuration was judged to be invalid is preserved in the policy preserving unit 121. After completion of the policy preserving processing 113 or if the user does not select the preservation of the policy, then the storage apparatus setting executing processing 114 is executed in accordance with the parameters.

After completion of the generation of the parameters by the above-mentioned processings, the policy-based setup engine 231 executes the storage apparatus setting executing processing 114 to set the parameters in the server 204, the switch 205, the storage 206 and the like of the storage apparatus.

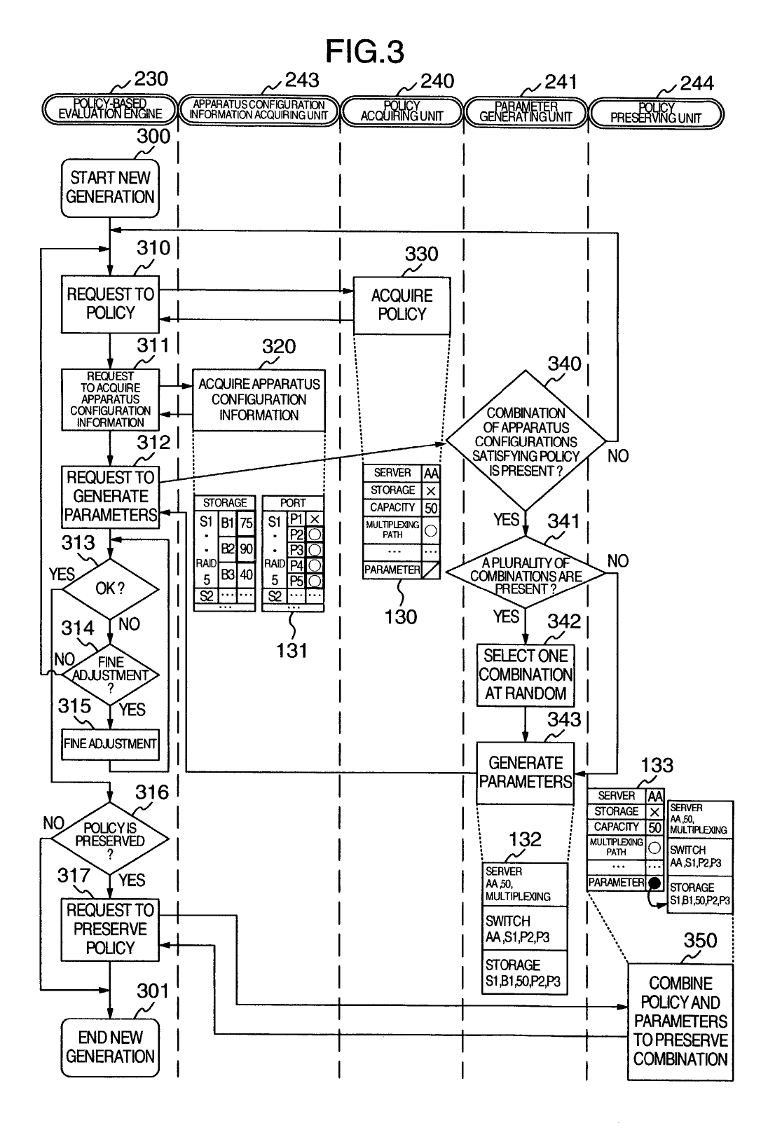

FIG. 3 is a detailed flow chart useful in explaining the processing procedure 150 in which the storage employing and managing system 220 of the present embodiment shown in FIG. 1 generates newly parameters in accordance with the request made by the user. In the flow chart, Steps 300, 301, and 310 to 317 are the processings which must be executed in the policy-based evaluation engine 230, Step 320 is the processing which must be executed in the apparatus configuration information acquiring unit 243, Step 330 is the processing which must be executed in the policy acquiring unit 240, Steps 340 to 343 are the processings which must be executed in the parameter generating unit 241, and Step 350 is the processing which must be executed in the policy preserving unit 244.

First of all, in Step 310, the policy-based evaluation engine 230 requests the policy acquiring unit 240 to acquire a policy. In response to this request, in Step 330, the policy acquiring unit 240 acquires the policy 130 from a user. In the policy 130, the user had carried out the specification in which “for a server AA, no storage is specified, but the capacity of 50 GB is assigned thereto, and a path is multiplexed”.

Next, in Step 311, the policy-based evaluation engine 230 requests the apparatus configuration information acquiring unit 243 to acquire apparatus configuration information. In response to this request, in Step 320, the apparatus configuration information acquiring unit 243 acquires the current apparatus configuration information 131. The apparatus configuration information 131 represents as the information with respect to the storages that “a storage S1 has an RAID5 configuration, a volume B1 has idle capacity of 75 GB, a volume B2 has idle capacity of 90 GB, and a volume B3 has idle capacity of 40 GB”, and also represents as the information with respect to the ports that “of ports in a storage S1, a port P1 is in use while ports P2 to P5 are yet unused”.

In response to the policy 130 and the apparatus configuration information 131, in Step 312, the policy-based evaluation engine 230 requests the parameter generating unit 241 to generate parameters. In response to this request, in Step 340, the parameter generating unit 241, by referring to the apparatus configuration information 131, judges whether or not the combination of the storage apparatus configurations satisfying the policy is present. In this case, it is understood that with respect to the idle capacity, “in a storage S1, each of volumes B1 and B2” satisfies the condition, while with respect to the ports, “ports P2 to P5” are available. Thus, since the combination satisfying the policy is present, the process returns back to Step 341. On the other hand, if such a combination is absent, then the process returns back to Step 310 to do over again the process from the processing for requesting the acquisition of the policy.

In Step 341, the parameter generating unit 241 judges whether or not a plurality of combinations each satisfying the policy are present. In the case of the present embodiment, since such a plurality of combinations are present, the process returns back to Step 342. On the other hand, if such a plurality of combinations are absent, then the process proceeds to Step 343 to generate parameters. In Step 342, for example, the parameter generating unit 241 selects at random one combination from a plurality of combinations which are present in accordance with a predetermined method and in Step 343, generates the combination thus determined in the form of the parameters 132.

In this case, the parameter that “a server name is AA, capacity is 50 GB, and a path is multiplexed” is generated for the server, the parameter that “an object of connection is a server AA and a storage S1, and an object of use is ports P2 and P3” is generated for the switch, and the parameter that “a storage name is S1, a volume name is B1, capacity is 50 GB, ports for use are P2 and P3” is generated for the storage. After completion of the generation of the parameters in Step 343, the process returns back to the policy-based evaluation engine 230.

Next, in Step 313, the policy-based evaluation engine 230 confirms the user whether or not the generated parameters may be available. If the generated parameters 132 are different from what the user intends, then the process proceeds to Step 314 to confirm whether or not the fine adjustment for the parameters should be carried out. If it is confirmed in Step 314 that no fine adjustment for the parameters should be carried out, then the process returns back to Step 310 to do over again the process from the request to acquire the policy. On the other hand, if it is confirmed in Step 314 that the fine adjustment for the parameters should be carried out, then the process proceeds to Step 315 to request the user to carry out the fine adjustment within the range of the apparatus configuration information 131. Then, the process returns back to Step 313 to confirm again whether or not those parameters may be available. In this case, in Step 313, it is assumed that the user judges that the generated parameters may be available.

In Step 316, the policy-based evaluation engine 230 confirms the user whether or not the policy should be preserved. If the user selects the preservation of the policy, then the process proceeds to Step 317. On the other hand, if the user does not select the preservation of the policy, then the processing for generating newly parameters is completed. In this case, it is assumed that a user selects the preservation of the policy. In Step 317, the policy-based evaluation engine 230 requests the policy preserving unit 244 to preserve the policy. In Step 350, the policy preserving unit 244 preserves the combination 133 of the policy 130 inputted by the user and the parameters 132 generated by the parameter generating unit 241 in the policy preserving unit 121. After completion of the policy preserving processing 350, the process returns back to the policy-based evaluation engine 230 to complete the processing 150 for generating newly parameters.

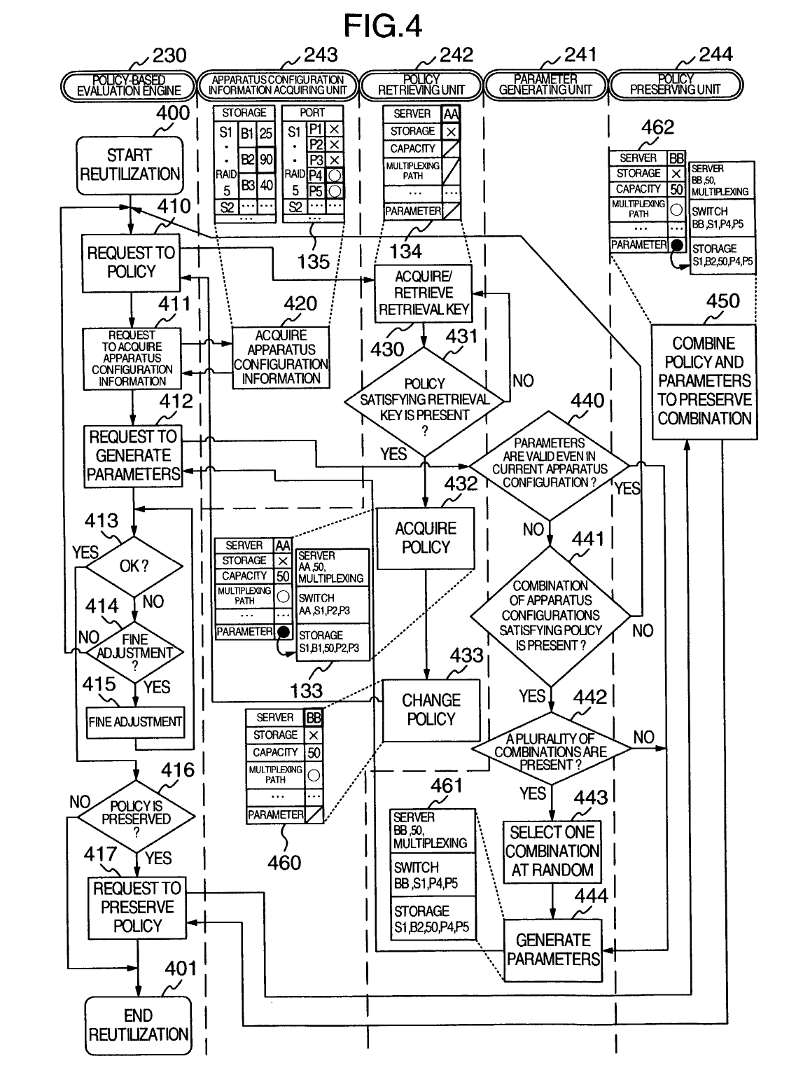

FIG. 4 is a detailed flow chart useful in explaining the processing procedure 151 in which the storage employing and managing system 220 of the present embodiment shown in FIG. 1 generates parameters in accordance with a request made by the user by reutilization. Steps 400, 401, and 410 to 417 are the processings which must be executed in the policy-based evaluation engine 230, Step 420 is the processing which must be executed in the apparatus configuration information acquiring unit 243, Steps 430 to 433 are the processings which must be executed in the policy retrieving unit 242, Steps 440 to 444 are the processings which must be executed in the parameter generating unit 241, and Step 450 is the processing which must be executed in the policy preserving unit 244.

First of all, in Step 410, the policy-based evaluation engine 230 requests the policy retrieving unit 242 to retrieve a policy. In response to this request, in Step 430, the policy retrieving unit 242 acquires the retrieval key 134 of the policy from the user to retrieve the policy satisfying the retrieval key 135 from the policy preserving unit 121. In Step 431, the policy retrieving unit 242 confirms whether or not the policy satisfying the retrieval key 134 is present. If the policy retrieving unit 242 confirms that the policy satisfying the retrieval key 134 is present, then in Step 432, the unit 242 acquires the policy 133 from the policy preserving unit 121. On the other hand, if the policy retrieving unit 242 does not confirm that the policy satisfying the retrieval key 134 is present, then the process returns back to Step 430 to do over again the process from the acquisition of the retrieval key and the retrieval processing. In this case, as shown in the flow chart of FIG. 3, it is assumed that the preserved policy 133 could be acquired. In Step 433, the policy retrieving unit 242 requests the user to change the acquired policy.

In this case, it is assumed that the user had carried out the specification that for the policy which was formerly generated, the same setting is wanted to carry out with respect to not “a server AA” but “a server BB”. After completion of the policy retrieving processing, the policy acquiring processing and the policy changing processing, the process returns back to the policy-based evaluation engine 230. Then, in Step 411, the policy-based evaluation engine 230 requests the apparatus configuration information acquiring unit 243 to acquire the apparatus configuration information. In response to this request, in Step 420, the apparatus configuration information acquiring unit 243 acquires the current apparatus configuration information 135. The apparatus configuration information 135 represents as the information with respect to the storages that “a storage S1 has an SAID5 configuration, a volume B1 has idle capacity of 25 GB, volume B2 has idle capacity of 90 GB, and volume B3 has idle capacity of 40 GB”, and also represents as the information with respect to the ports that “of ports in a storage S1, ports P1 to P3 are in use, while ports P4 and P5 are yet unused”.

In response to the policy 133 and the apparatus configuration information 135, in Step 412, the policy-based evaluation engine 230 requests the parameter generating unit 241 to generate parameters. In response to this request, in Step 440, the parameter generating unit 241 judges on the basis of the apparatus configuration information 135 whether or not the parameters combined with the policy 133 are valid even in the current apparatus configuration. If it is judged in Step 440 that the parameters combined with the policy 133 are valid even in the current apparatus configuration, then the process proceeds to Step 444 to complete the parameter generating processing. On the other hand, if it is judged in Step 440 that the parameters combined with the policy 133 are invalid even in the current apparatus configuration no longer, then the process proceeds to Step 441. In this case, since the server to be set is “BB”, any of the parameters is invalid. In Step 441, the parameter generating unit 241 judges on the basis of the apparatus configuration information 135 whether or not a combination of the storage apparatus configurations satisfying the policy is present. In this case, it is understood that with respect to the idle capacity, from the apparatus configuration information 135, 2in a storage S1, a volume B2” satisfies the condition, while with respect to the ports, each of “ports P4 and P5” is available. Since the combination satisfying the policy is present, the process proceeds to Step 442. On the other hand, if the combination satisfying the policy is absent, then the process returns back to Step 410 to do over again the process from the request to retrieve a policy.

In Step 442, the parameter generating unit 241 judges on the basis of the apparatus configuration information 135 whether or not a plurality of combinations each satisfying the policy are present. In this case, since a combination satisfying the condition is also present in the storage “S2” and hence such a plurality of combinations are present, the process proceeds to Step 443. On the other hand, if such a plurality of combinations are absent, then the process proceeds to Step 444 to generate parameters. In Step 443, the parameter generating unit 241 selects at random one of such a plurality of combinations which are present to generate the one in the form of parameters 461 in Step 444. In this case, the parameter that “a server name is BB, capacity is 50 GB and a path is multiplexed” is generated for the server, the parameter that “an object of connection is a server BB and a storage S1, and ports to be used are ports P4 and P5” is generated for the switch, and the parameter that “a storage name is S1, a volume name is B2, capacity is 50 GB, and ports to be used are ports P4 and P5” is generated for the storage. After completion of the generating of the parameters in Step 444, the process returns back to the policy-based evaluation engine 230.

Next, in Step 413, the policy-based evaluation engine 230 confirms to the user whether or not the parameters thus generated may be available. If the parameters 461 thus generated are different from what the user intends, then the process proceeds to Step 414 to confirm whether or not the fine adjustment for the parameters should be carried out. If it is confirmed that no fine adjustment for the parameters should be carried out, then the process returns back to Step 410 to do over again the process from the request to retrieve a policy. On the other hand, if it is confirmed that the fine adjustment for the parameters should be carried out, then the process proceeds to Step 415 to request the user to carry out the fine adjustment within the range of the apparatus configuration information 135. Then, the process returns back to Step 413 to confirm whether or not those parameters may be available. In this case, in Step 413, it is assumed that the user judges that the parameters thus generated may be available.

In Step 416, the policy-based evaluation engine 230 confirms the user whether or not the policy should be preserved. If the user selects the preservation of the policy, then the process proceeds to Step 417. On the other hand, if the user does not select the preservation of the policy, then the generation processing based on the reutilization of the parameters is completed. In this case, it is assumed that the user selects the preservation of the policy. In Step 417, the policy-based evaluation engine 230 requests the policy preservation unit 244 to preserve the policy. In Step 450, the policy preserving unit 244 combines the policy 460 which was changed after completion of the retrieval with the parameters 461 which were generated by the parameter generating unit 241 to preserve the combination thus obtained in the policy preserving unit 121 in the form of the policy 462. After completion of the policy preserving processing 450, the process returns back to the policy-based evaluation engine 230 to complete the generation processing 151 based on reutilization of the parameters.

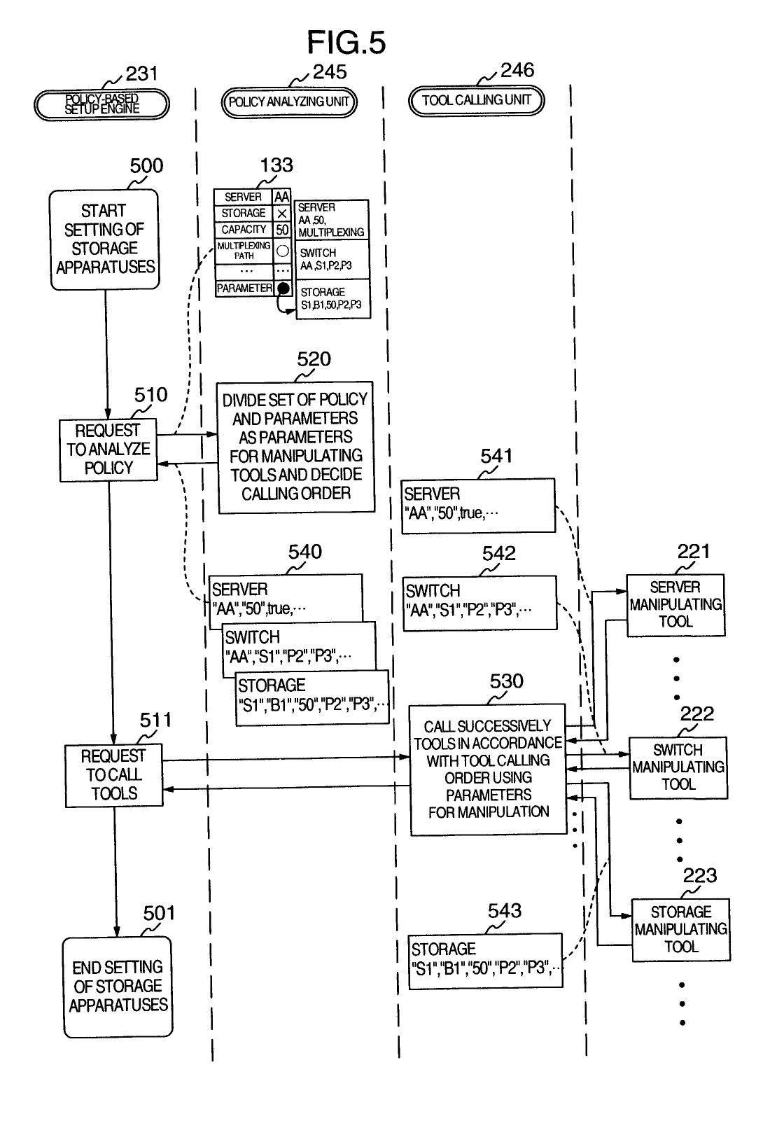

FIG. 5 is a detailed flow chart useful in explaining the processing procedure in which the storage employing and managing system 220 of the present embodiment shown in FIG. 1, in Step 114, carries out the setting of the storage apparatuses in accordance with the parameters after completion of the generation of the parameters. Steps 500, 501, 510, and 511 are the processings which must be executed in the policy-based setup engine 231, Step 520 is the processing which must be executed in the policy analyzing unit 245, and Step 530 is the processing which must be executed in the tool calling unit 246.

First of all, in Step 510, the policy-based setup engine 231 requests the policy analyzing unit 245 to analyze the policy. In response to this request, in Step 520, the policy analyzing unit 245 receives as its input a set 133 of policy and parameters to divide the parameters every apparatus in the form of parameters 540 used to call the storage apparatus setting tools and to determine the order of calling the tools on the basis of a predetermined procedure of activating the apparatuses. Next, the policy-based setup engine 231 requests the tool calling unit 246 to call the tools. In response to this request, in Step 530, the tool calling unit 246 calls the tools for manipulating the storage apparatuses such as a tool 221 for manipulating the server, a tool 222 for manipulating the switch, and a tool 223 for manipulating the storage in accordance with the calling order generated in Step 520, a parameter 541 for the server, a parameter 542 for the switch and a parameter 543 for the storage to carry out the setting of the storage apparatuses. After completion of the tool calling processing 530, the process returns back to the policy-based setup engine 231 to complete the processing for setting the storage apparatuses.

The processings in the flow chart shown above are executed in the form of a program in the computer system 200 shown in FIG. 2. However, this program, as shown in FIG. 2, is not necessarily limited to one which is stored in the external storage device 202 connected physically to the computer system 200. That program may also be stored in a storage medium, to and from which information can be written and read out in the computer system 200, such as a hard disc device, or a floppy disc device which is not physically connected to the computer system 200. In addition, that program may also be stored in the external storage device which is connected to a computer system different from the computer system 200 shown in FIG. 2 through a network.

In the above-mentioned embodiment, when the parameters shown in FIG. 3 are newly generated and when the parameters shown in FIG. 4 are generated by reutilization, if a plurality of combinations of the parameters each satisfying the policy are present, in Steps 342 and 443, one combination is determined at random from them. Now, as for a method of determining one combination, the following four methods may be employed.

(1) A plurality of combinations are presented to the user to require the user to select one of them, thereby determining one combination.

(2) One combination is determined from a plurality of combinations in accordance with the round robin method.

(3) One combination is determined from a plurality of combinations with the storage apparatus having the shortest operating time being given priority.

(4) One combination is determined from a plurality of combinations with the storage apparatus having the longest operating time being given priority.

In addition, when the setting of the storage apparatuses shown in FIG. 5 is carried out, in Step 530, the tool 221 for manipulating the server, the tool 222 for manipulating the switch, and the tool 223 for manipulating the storage as the tools for manipulating the storage apparatuses, respectively, are called to execute the setting processing. Now, the storage apparatuses may be directly manipulated using the parameter 541 for the server, the parameter 542 for the switch, and the parameter 543 for the storage which were generated without calling any of the tools for manipulating the storage apparatuses to carry out the setting.

As set forth hereinabove, according to the present invention, in a storage employing and managing system, an automated function by a unified interface for the parameter setting for storage apparatuses is provided so that a system administrator does not need to manipulate individually tools while taking the consistency and order between the storage apparatus settings into consideration and hence it is possible to reduce the operation and management cost.

According to the present invention, a unified interface for the storage apparatus setting, and an automated function for the parameter setting are both provided, whereby it is possible to reduce the operation and management cost for a system administrator.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A storage employing and managing method of setting storage apparatuses in accordance with parameters with respect to storage apparatuses including at least a storage, a switch and a server, said method comprising the steps of:
acquiring the condition for setting of storage apparatuses, inputted by a user, in the form of a policy;
acquiring configuration information of said storage apparatuses;
determining a combination of settings satisfying the policy by referring to the configuration information of said storage apparatuses;
generating parameters for tools for manipulating said storage apparatuses such that the combination is set in said storage apparatuses; and
calling said tools using the parameters to set said storage apparatuses.

2. A storage employing and managing method according to claim 1, further comprising the steps of:
combining the policy and the generated parameters for the storage apparatus setting to hold the combination thereof on storage mean;
when making a request to reutilize the policy, retrieving the policy corresponding to the inputted retrieval key from said storage means;
acquiring the configuration information of said storage apparatuses;
confirming whether or not the parameters preserved in combination with the policy meet the storage apparatus configuration thus acquired and if not, regenerating parameters; and
calling the tools using the parameters thus regenerated to set said storage apparatuses.

3. A storage employing and managing method according to claim 1, wherein the processing for setting storage apparatuses is directly executed using the generating parameters.

4. A storage employing and managing method according to claim 1, wherein when a plurality of combinations of said storage apparatus configurations each satisfying the policy are present, one combination is selected from the plurality of predetermined combinations to determine the combination to be set of the configurations of the storage apparatuses.

5. A storage employing and managing method according to claim 1, wherein when a plurality of combinations of said storage apparatus configurations each satisfying the policy are present, one combination is selected at random from the plurality of combinations to determine the combination to be set of the configurations of the storage apparatuses.

6. A storage employing and managing method according to claim 1, wherein when a plurality of combinations of said storage apparatus configurations each satisfying the policy are present, one combination is selected from the plurality of combinations in accordance with a round robin method to determine the combination to be set of the configurations of the storage apparatuses.

7. A storage employing and managing method according to claim 1, wherein when a plurality of combinations of said storage apparatus configurations each satisfying the policy are present, one combination is selected from the plurality of combinations with the storage apparatus having the shortest operating time being given priority to determine the combination to be set of the configurations of the storage apparatuses.

8. A storage employing and managing method according to claim 1, wherein when a plurality of combinations of said storage apparatus configurations each satisfying the policy are present, one combination is selected from the plurality of combinations with the storage apparatus having the longest operating time being give priority to determine the combination to be set of the configurations of the storage apparatuses.

9. A storage employing and managing system for setting storage apparatuses in accordance with parameters with respect to storage apparatuses including at least a storage, a switch and a server, said system comprising:
means for acquiring the condition for setting of storage apparatuses, inputted by a user, in the form of a policy;
means for acquiring configuration information of said storage apparatuses;
means for determining a combination of settings satisfying the policy by referring to the configuration information of said storage apparatuses;
means for generating parameters for tools for manipulating said storage apparatuses such that the combination is set in said storage apparatuses; and
means for calling said tools using the parameters to set said storage apparatuses.

10. A storage employing and managing program for implementing a method of setting storage apparatuses in accordance with parameters with respect to storage apparatuses including at least a storage, a switch and a server, said method comprising the steps of:
acquiring the condition for setting of storage apparatuses, inputted by a user, in the form of a policy;
acquiring configuration information of said storage apparatuses;
determining a combination of settings satisfying the policy by referring to the configuration information of said storage apparatuses;
generating parameters for tools for manipulating said storage apparatuses such that the combination is set in said storage apparatuses; and
calling said tools using the parameters to set said storage apparatuses.

11. A computer-readable recording medium having, recorded therein, a storage employing and managing program for implementing a method of setting storage apparatuses in accordance with parameters with respect to storage apparatuses including at least a storage, a switch and a server, said method comprising the steps of:
acquiring the condition for setting of storage apparatuses, inputted by a user, in the form of a policy;
acquiring configuration information of said storage apparatuses;
determining a combination of settings satisfying the policy by referring to the configuration information of said storage apparatuses;
generating parameters for tools for manipulating said storage apparatuses such that the combination is set in said storage apparatuses; and
calling said tools using the parameters to set said storage apparatuses.
